(19) United States
(12) Patent Application Publication
(10) Pub. No.: US 2017/0345096 A1
(43) Pub. Date: Nov. 30, 2017

(54) METHOD AND SYSTEM FOR PROVIDING A DASHBOARD FOR DETERMINING RESOURCE ALLOCATION FOR MARKETING

(71) Applicant: BOSTON CONSULTING GROUP UK LLP, London (GB)

(72) Inventors: ANDRIS UMBLIJS, WOKING (LV); JANMESH SRIVASTAVA, ISLEWORTH (GB); MICHEL BROCHMANN, Paris (FR)

(73) Assignee: BOSTON CONSULTING GROUP UK LLP, LONDON (GB)

(21) Appl. No.: 15/169,723

(22) Filed: May 31, 2016

(51) Int. Cl. G06Q 40/06; G06Q 30/02; G06Q 40/00

(52) U.S. Cl. CPC G06Q 40/06; G06Q 40/12; G06Q 30/0201

(57) ABSTRACT

Methods and system are described for determining marketing fund value for a product. Multiple input variables are determined to estimate one or more dependent variables. The marketing fund value is calculated based on a combined function of one or more dependent variables. A dashboard has been provided for displaying the marketing fund value by means of a plurality of infographics along with the one or more dependent variables.

### FIELD OF THE DISCLOSURE

The present disclosure relates generally to investment decision models, and more particularly, to a method for making decisions for allocating funds for marketing initiatives.

### BACKGROUND

The subject matter discussed in the background section should not be assumed to be prior art merely as a result of its mention in the background section. Similarly, a problem mentioned in the background section or associated with the subject matter of the background section should not be assumed to have been previously recognized in the prior art. The subject matter in the background section merely represents different approaches, which in and of themselves may also correspond to implementations of the claimed technology.

Most of the organisations today engage in marketing activities to maintain and improve market share. It is critical for the organisations to critically monitor the capital spent on such marketing activities and to decide the future investments to be made for marketing in a particular geography and for a particular product. Many large companies spend millions of dollars on Advertising and Promotion expenditure. However, despite the amount of money spent on marketing campaigns, the organisations often miscalculate the budget for a particular product or a particular segment of products.

However, often the organisations focus on a relatively small subset of variables when trying to articulate appropriate marketing strategies and courses of action to follow when marketing particular products and/or services. Furthermore, the means available to such companies at present are limited and do not focus on providing information for analyzing the effect of one or more variables on future marketing initiatives. Although some computer-based applications facilitate analysis of marketing data, but such applications offer only limited help and do not facilitate the entire process of creating viable marketing models, and formulating appropriate marketing strategies based on such models.

Some typical efforts for analyzing marketing initiatives include generating reports that indicate sales volume for the products being marketed. However, the generation of rudimentary reports only gives a basic understanding of how effective a marketing campaign is in improving sales. Furthermore, these reports may not be very beneficial for different users to optimize a marketing campaign and may not be the most accurate gauge of a marketing campaign's effectiveness.

In light of the aforementioned drawbacks associated with the existing techniques, there exists a need for methods and system that provide a platform that enables maximizing the marketing investment value. The method and system should enable fact based decision making and consider all aspects of brand performance. The method and system should enable optimal allocation of resources and making spending decisions for marketing initiatives across markets and brands.

### BRIEF SUMMARY

It will be understood that this disclosure in not limited to the particular systems, and methodologies described, as there can be multiple possible embodiments of the present disclosure which are not expressly illustrated in the present disclosure. It is also to be understood that the terminology used in the description is for the purpose of describing the particular versions or embodiments only, and is not intended to limit the scope of the present disclosure.

In an example embodiment, a method for determining a marketing fund value for a product is described. The method comprises one or more computer implemented steps. The steps comprise of identifying, by a processor executing computer instructions, a plurality of input variables to estimate one or more dependent variables. The method also comprises estimating one or more dependent variables comprising a product category factor, a product share factor, a product profit factor, a product advertisement factor, and a product ROI factor. The product category is based on category growth value and category size value for the product. The product share factor is based on share change and brand share of the product. The product profit factor is based on profit margin change and profit margin for the product. The product advertisement factor is based on share of voice and share of market for the product. The product ROI factor is based on short term return on investment and long term return on investment for the product. Finally, the marketing fund value is calculated which is based on a combined function of the one or more dependent variables.

In another example embodiment, a system for marketing fund value for a product is described. The system comprises of one or more databases, a memory, and a processor. The one or more databases store data related to one or more input variables. The memory stores one or more input variables, one or more dependent variables, and one or more program modules. The processor executes the one or more program modules stored in the memory for executing a plurality of method steps. The method steps comprise of identifying a plurality of input variables to estimate one or more dependent variables. The method also comprises estimating one or more dependent variables comprising a product category factor, a product share factor, a product profit factor, a product advertisement factor, and a product ROI factor. The product category factor is based on category growth value and category size value for the product. The product share factor is based on share change and brand share of the product. The product profit factor is based on profit margin change and profit margin for the product. The product advertisement factor is based on share of voice and share of market for the product. The product ROI factor is based on short term return on investment and long term return on investment for the product. Finally, the marketing fund value is calculated which is based on a combined function of the one or more dependent variables.

Other systems, methods, features and advantages will be, or will become, apparent to one with skill in the art upon examination of the following figures and detailed description. It is intended that all such additional systems, methods, features and advantages be included within this description, be within the scope of the embodiments, and be protected by the following claims and be defined by the following claims. Further aspects and advantages are discussed below in conjunction with the description.

### BRIEF DESCRIPTION OF THE DRAWINGS

The accompanying drawings illustrate various embodiments of systems, methods, and embodiments of various other aspects of the disclosure. Any person with ordinary skills in the art will appreciate that the illustrated element boundaries (e.g. boxes, groups of boxes, or other shapes) in the figures represent one example of the boundaries. It may be that in some examples one element may be designed as multiple elements or that multiple elements may be designed as one element. In some examples, an element shown as an internal component of one element may be implemented as an external component in another, and vice versa. Furthermore, elements may not be drawn to scale. Non-limiting and non-exhaustive descriptions are described with reference to the following drawings. The components in the figures are not necessarily to scale, emphasis instead being placed upon illustrating principles.

FIG. 1 illustrates a block diagram of a system for providing a platform for determining resource allocation for marketing, according to an embodiment.

FIG. 2 shows a computer system configured to provide a hardware platform for the system shown in FIG. 1, according to an embodiment.

FIG. 3 illustrates a schematic diagram of a system for providing a platform for determining resource allocation for marketing, according to an embodiment.

FIG. 4 illustrates a flowchart of a method for providing a platform for determining resource allocation for marketing, according to an embodiment.

FIG. 5 illustrates a dashboard showing overall statistics of one or more brands of products, according to an example embodiment.

FIG. 6 illustrates a dashboard showing a chart depicting brand growth and short term ROI for a brand, according to an example embodiment.

FIG. 7 illustrates a dashboard showing a chart depicting relative prices of one or more brand of products in a plurality of locations, according to an example embodiment.

FIG. 8 illustrates a dashboard showing a chart depicting marketing fund allocation for various products in various corresponding geographical regions, according to an example embodiment.

FIG. 9 illustrates a dashboard showing a chart depicting change in marketing fund allocated to various products in various corresponding geographical regions, according to an example embodiment.

### DETAILED DESCRIPTION

Some embodiments of this disclosure, illustrating all its features, will now be discussed in detail. The words “comprising,” “having,” “containing,” and “including,” and other forms thereof, are intended to be equivalent in meaning and be open ended in that an item or items following any one of these words is not meant to be an exhaustive listing of such item or items, or meant to be limited to only the listed item or items.

It must also be noted that as used herein and in the appended claims, the singular forms “a,” “an,” and “the” include plural references unless the context clearly dictates otherwise. Although any systems and methods similar or equivalent to those described herein can be used in the practice or testing of embodiments of the present disclosure, the preferred, systems and methods are now described.

Embodiments of the present disclosure will be described more fully hereinafter with reference to the accompanying drawings in which like numerals represent like elements throughout the several figures, and in which example embodiments are shown. Embodiments of the claims may, however, be embodied in many different forms and should not be construed as limited to the embodiments set forth herein. The examples set forth herein are non-limiting examples and are merely examples among other possible examples.

The dashboards provided by the existing technology provide only a single lens approach wherein marketing budget can be decided based on a single variable. Such art does not provide an accurate estimate of the resources to be allocated. Moreover, the problems related to retrieving and utilizing information from a plurality of sources based on the requirement of a manager is not resolved by the existing art. The systems and methods described according to the one or more embodiments of the present disclosure provide a multi-lens approach for analyzing marketing initiatives. The multi-lens approach of the described method and system facilitates fact based decision making and enables decision making based on combined effect of a plurality of market variables and brand performance. The methods and systems described herein provide a platform that automates collecting, cleaning, and synchronizing the marketing data available from a plurality of data sources.

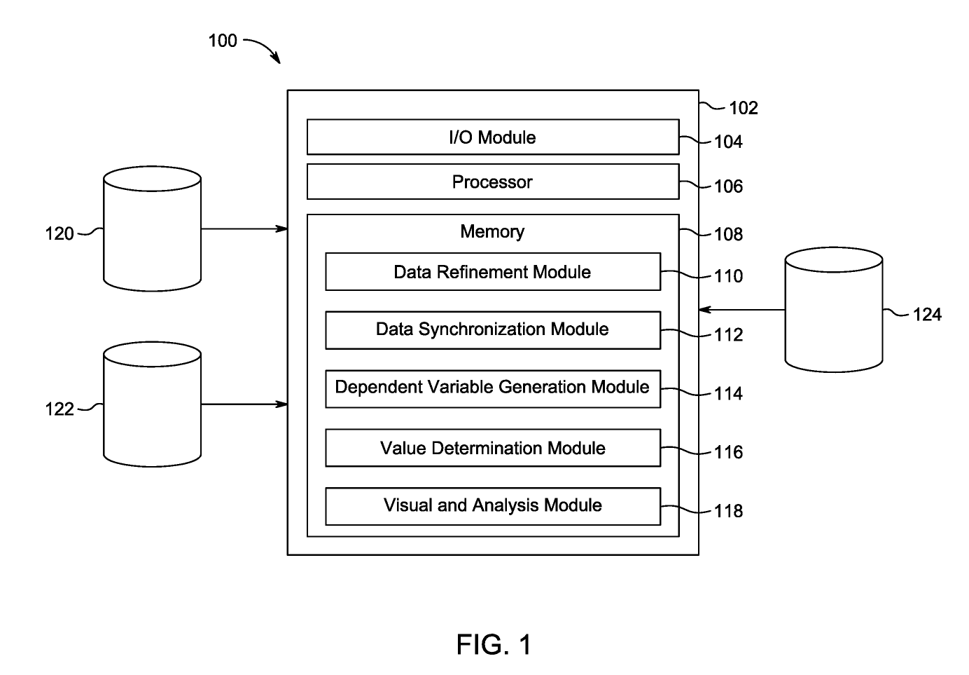

FIG. 1 illustrates a block diagram of a system for providing a platform for determining resource allocation for marketing, according to an embodiment. The system 100 comprises of a computing system 102, and one or more remote servers (120, 122, and 124). The computing system 102 comprises of an I/O module 104, a processor 106, and a memory 108. The computing system 102 along with the one or more remote servers (120, 122, and 124) displays a dashboard related to the marketing resource allocation platform. The system 100 may retrieve required data from the one or more remote servers (120, 122, and 124) and may process such retrieved data that is then displayed to a user accessing the computing system 102. The marketing resource allocation platform may enable a user to select one or more input variables, one or more dependent variables, and one or more marketing parameters as required by the user. The computing system 102 may generate one or more infographics for representing the data as sources from the one or more remote servers (120, 122, and 124), or for representing the input variables and dependent variables, or for representing one or more processed outputs. In an aspect, the computing system 102 may be a personal computer, a tablet, a smartphone, a mobile phone, a laptop, and the like.

The processor 106 may execute computer program instructions stored in the memory 108. The processor 106 may also be configured to decode and execute any instructions received from the remote servers (120, 122, and 124). The processor 106 may also execute a client application for desired functioning of the computing system 102. The processor 106 may include one or more general purpose processors (e.g., INTEL microprocessors) and/or one or more special purpose processors (e.g., digital signal processors). The processor 106 is configured to execute one or more computer-readable program instructions, such as program instructions to carry out any of the functions described in this description.

The memory 108 may include a computer readable medium. A computer readable medium may include volatile and/or non-volatile storage components, such as optical, magnetic, organic or other memory or disc storage, which may be integrated in whole or in part with a processor, such as processor 106. Alternatively, the entire computer readable medium may be remote from processor 106 and coupled to processor 106 by connection mechanism and/or network cable. In addition to memory 108, there may be additional memories that may be coupled with the processor 106.

The I/O module 104 may be configured to receive one or more user inputs for controlling the marketing resource allocation platform as described herein. Further, the I/O module 104 may be configured for displaying the dashboard related to the marketing resource allocation platform. The I/O module 104 may comprise of a QWERTY keyboard for entering the user inputs and a display screen for displaying the dashboard. In an alternate aspect, the I/O module 104 may be a touch screen facilitating a QWERTY keyboard on the display screen.

The remote servers (120, 122, and 124) may be coupled to one or more databases for storing data related to one or more input variables. The data stored in the one or more databases may include the underlying data corresponding to the products and/or services with respect to which the marketing resources are to be allocated. Data stored in the one or more databases may provide historical information about a plurality of market drivers that impact the marketing behavior for the corresponding products and/or services in a particular geographical region. For example, the data may include advertising expenditures, size and deployment of the sales force, etc. Data stored in the one or more databases may also include historical sales and performance data for the products and services to be analyzed. The one or more databases may also store all types of client data that affect the performance of a client's marketing of its products and/or services, including manufacturing capacity, inventory levels, etc. In an aspect, the data stored in the one or more databases may be cleansed by the corresponding remote server. In an alternate aspect, the data stored in the one or more databases may be cleansed by the processor 106.

In an example embodiment, at least one server may belong to various retail panels that source data from a plurality of inventory management units, stock keeping units, and the like. The data sourced from the stock keeping units may include data such as volume of one or more products sold, value of the total inventory of products, price of one or more products, base price of one or more products, promotional price of one or more products, and the like. One or more servers may also belong to one or more media agencies tracking one or more factors or input variables for one or more products in one or more geographies. The data sourced from the media agencies may include data such as Gross Rating Points for one or more advertisements of one or more products, reach and frequency of the advertisement, impact of advertisement medium like traditional medium or digital medium. One or more servers may also belong to particular digital marketing mediums such as product website, blogs, search engines, social networking services, social networking forums, and the like. One or more servers may also belong to sources managing the brand financials that may store data such as profit and loss statements of a brand, trade value, trade volume, net sales value, Cost of goods sold, gross profit, promotion related data, marketing related data, and the like. One or more servers may also belong to one or more sources tracking various macroeconomic factors affecting the brand/product and may store data such as new product launches, seasonal events, supply constraints, and the like.

The computing system 102 retrieves data related to one or more input variables from the one or more databases related to the one or more remote servers (120, 122, and 124). The one or more input variables may comprise category growth, category size, brand share change, brand share, profit margin change for a brand/product, profit margin for a brand/product, share of voice for a brand/product, share of market of a brand/product, short term ROI of a brand/product, long term ROI of a brand/product. The various input variables may be selected by a manager based on the various aspects related to a particular industry. For example, a manager in FMCG industry may select different input variables as compared to a manager in Automotives industry. These input variables may either be generated by the one or more remote server (120, 122, and 124) or may be generated by the computing system 102 upon retrieving data from the one or more remote server (120, 122, and 124). The processor 106 then executes one or more program modules stored in the memory 108. The memory 108 may comprise of a data refinement module 110, a data synchronization module 112, a dependent variable generation module 114, a value determination module 116 and a visual and analysis module 118. The data refinement module 110 upon execution by the processor 106 may refine or cleanse the data retrieved from one or more remote servers (120, 122, and 124). The data synchronization module 112 upon execution by the processor 106 may synchronize the cleansed data, for example, the data synchronization module 112 may relate or identify one or more input variables that may be correlated for determination of one or more dependent variables. The dependent variable generation module 114 estimates one or more dependent variables by utilizing the one or more input variables. The dependent variable generation module 114 may determine a product category factor by calculating a ratio of category growth value and category size value for the product. The dependent variable generation module 114 may determine a product share factor by calculating a ratio of share change and brand share of the product. The dependent variable generation module 114 may determine a product profit factor by calculating a ratio of profit margin change and profit margin for the product. The dependent variable generation module 114 may determine a product advertisement factor by calculating a ratio of share of voice and share of market for the product. The dependent variable generation module 114 may determine a product ROI factor by calculating a ratio of short term return on investment and long term return on investment for the product. The dependent variable generation module 114 may also determine a product investment factor by calculating a ratio of investment in marketing of the product and profit of the product. The various dependent variables upon determination may be displayed on the computing system 102 by means of the visual and analysis module 118 as and when required by the user. The visual and analysis module 118 enables a user to generate various infographics such as bar graphs, pie charts, tables, etc. for better understanding of various factors affecting a brand. In an aspect, the infographics may be generated upon selecting a dependent variable for a brand/product and a particular geographical location for which the infographics are to be generated may also be selected. In an alternate aspect, the infographics may be generated for a particular geographical location. The value determination module 116 enables calculating a marketing investment value. The value determination module 116 may enable either inputting one or more weights related to each of the one or more dependent variables or alternatively may automatically determine one or more weights. Finally, the marketing fund value is calculated based on a combined function of one or more weights and the one or more dependent variables. In an aspect, the marketing fund value may be a currency value indicating the amount of funds that need to be allocated for a particular brand in a financial year or a particular quarter. In an alternate aspect, the marketing fund value may be a percentage increase or percentage decrease required in a particular time period vis-à-vis a previous financial year or a previous quarter.

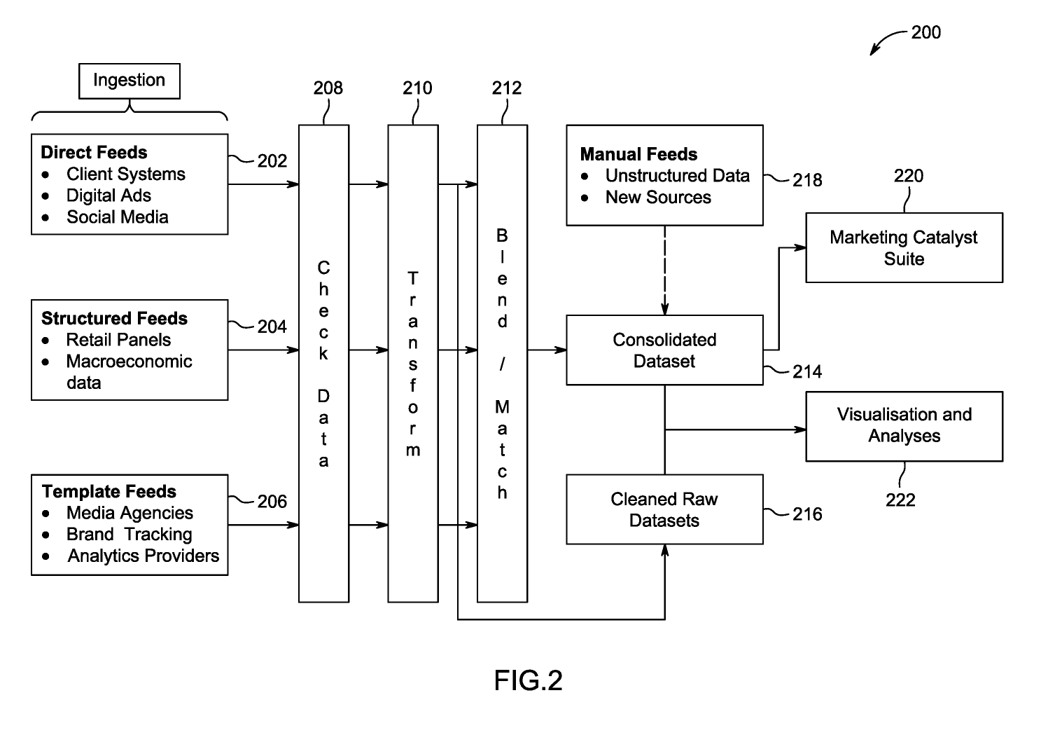

FIG. 2 illustrates a schematic diagram of a system for providing a platform for determining resource allocation for marketing, according to an embodiment. The system 200 comprises of a data ingestion level where data is retrieved from a plurality of sources such as direct feeds 202, structured feeds 204, and template feeds 206. The direct feeds 202 may be retrieved from one or more Client Systems, Digital Ads, and Social Media. The structured feeds 204 may be retrieved from one or more retail panels, and one or more servers storing macroeconomic data. The template feeds 206 may be retrieved from one or more Media Agencies, one or more Brand Tracking agencies, and one or more Analytics Providers. The data retrieved from the ingestion level is then checked at check data level 208. At check data level 208, the retrieved data is checked for any discrepancies and data coherence. The cleansed data from the check data level 208 is then utilized by the data transformation level 210 for determining one or more input variables. At the data transformation level 210 the data is transformed into category growth value, category size value, share change, brand share, profit margin, share of voice, share of market, short term return on investment, long term return on investment for the product, investment in marketing of the product, profit of the product, and the like. The data transformation level 210 results in cleansed raw datasets 216. At blend/match level 212, the input variables are matched for determining consolidated data sets 214 and may be further utilized for determining one or more dependent variables. Further, one or more manual feeds 218 may be used for retrieving additional data from one or more unstructured data sets or one or more new sources. The consolidated data sets 214 and cleansed raw datasets 216 are then further utilized for creating one or more data visualizations and also for determining a marketing investment value. The consolidated data sets 214 may also be utilized for creating a marketing catalyst suite 220 that stores all the data related to all the brands and products of an organisation.

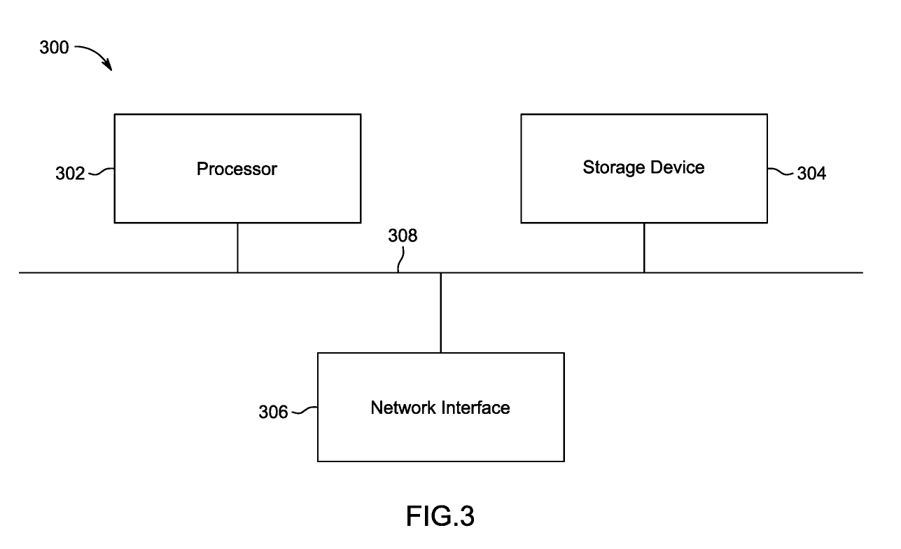

FIG. 3 shows a computer system configured to provide a hardware platform for the system shown in FIG. 1, according to an embodiment. FIG. 3 shows a computer system 300 that may be used as a hardware platform for the system. The computer system 300 may be used as a platform for executing one or more of the steps, methods, and functions described herein that may be embodied as software stored on one or more computer readable storage devices, which are hardware storage devices. The computer system 300 includes a processor 302 or processing circuitry that may implement or execute software instructions performing some or all of the methods, functions and other steps described herein. Commands and data from the processor 302 are communicated over a communication bus 308. The computer system 300 also includes a computer readable storage device 304, such as random access memory (RAM), where the software and data for processor 302 may reside during runtime. The storage device 304 may also include non-volatile data storage. The computer system 300 may include a network interface 306 for connecting to a network. It will be apparent to one of ordinary skill in the art that other known electronic components may be added or substituted in the computer system 300. Further, it needs to be noted that the various program modules as described in FIG. 1 increases the efficiency and throughput of the computer system for particularly processing operations related to the platform as described herein and also for performing the various calculations as required by the described method.

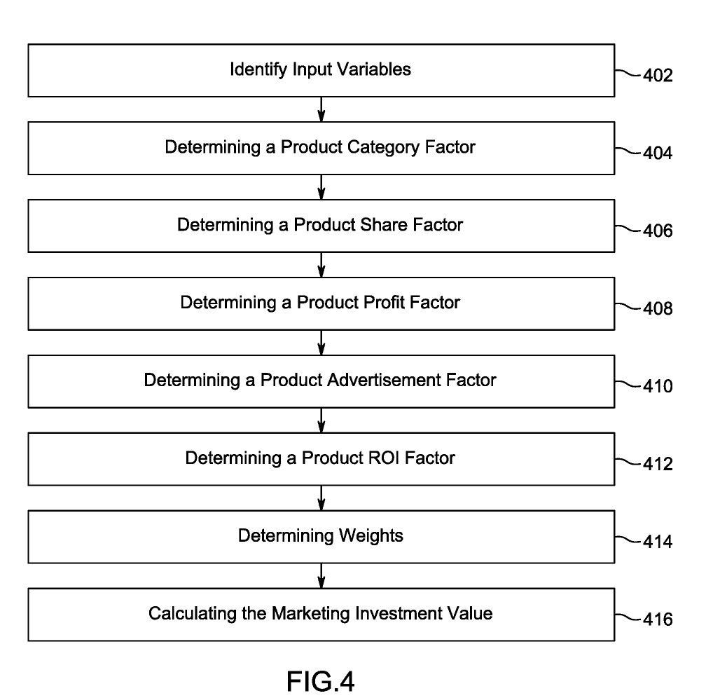

FIG. 4 illustrates a flowchart of a method for providing a platform for determining resource allocation for marketing, according to an embodiment. At step 402, a plurality of input variables is identified by the processor 106 to estimate one or more dependent variables. The dependent variables may either be retrieved from one or more remote servers coupled with one or more databases or may generated by the processor 106 upon retrieving marketing data from one or more sources. The step of identifying the plurality of input variables comprises of retrieving data related to the plurality of input variables from a plurality of sources and then refining the retrieved data.

Upon identifying the input variables one or more dependent variables are determined. At step 404, a product category factor is determined by calculating a ratio of category growth value and category size value for the product. At step 406, a product share factor is determined by calculating a ratio of share change and brand share of the product. At step 408, a product profit factor is determined by calculating a ratio of profit margin change and profit margin for the product. At step 410, a product advertisement factor the product advertisement factor is a ratio of share of voice and share of market for the product. At step 412, determining a product ROI factor, the product ROI factor is determined by calculating a ratio of short term return on investment and long term return on investment for the product. Further, one or more other dependent variables may also be determined such as by determining a product investment factor by calculating a ratio of investment in marketing of the product and profit of the product.

At step 414, one or more weights related to each of the one or more dependent variables may be determined. In an aspect, the one or more weights may be empirically derived. In another aspect, the one or more weights may be inputted by the user. At step 416, the marketing fund value is calculated based on a combined function of one or more weights and the one or more dependent variables.

In one example embodiment, the marketing fund value may be calculated based on zero based budgeting wherein each of the one or more weights is multiplied with the corresponding dependent variable. Then, a future profit potential factor is determined by multiplying the weighted product category factor, weighted product share factor, and weighted product profit factor. Finally, the future profit potential factor is added with the weighted product advertisement factor, and the weighted product ROI factor.

In another example embodiment, the marketing fund value may be calculated based on history plus based budgeting wherein each of the one or more weights is multiplied with the corresponding dependent variable. Then, a sum of the weighted product category factor, the weighted product share factor, the weighted product profit factor, the weighted product advertisement factor, the weighted product ROI factor, and a historic budget value is calculated. In an aspect, the historic budget value is the total budget allocated to the product in a previous financial year.

The flow chart of FIG. 4 shows a plurality of method steps for determination of resources to be allocated for marketing, according to an embodiment. In this regard, each block may represent a module, segment, or portion of code, which comprises one or more executable instructions for implementing the specified logical function(s). It should also be noted that in some alternative implementations, the functions noted in the blocks may occur out of the order noted in the drawings. For example, two blocks shown in succession in FIG. 4 may in fact be executed substantially concurrently or the blocks may sometimes be executed in the reverse order, depending upon the functionality involved. Any process descriptions or blocks in flow charts should be understood as representing modules, segments, or portions of code which include one or more executable instructions for implementing specific logical functions or steps in the process, and alternate implementations are included within the scope of the example embodiments in which functions may be executed out of order from that shown or discussed, including substantially concurrently or in reverse order, depending on the functionality involved. In addition, the process descriptions or blocks in flow charts should be understood as representing decisions made by a hardware structure such as a state machine.

In an example embodiment, a non-transitory computer readable medium is described that stores computer readable instructions that when executed by a processor perform a method for determining marketing fund value for a product, the method comprising. The method comprise of identifying, by a processor executing computer instructions, a plurality of input variables to estimate one or more dependent variables. The method also comprises estimating one or more dependent variables including a product category factor, a product share factor, a product profit factor, a product advertisement factor, and a product ROI factor. The product category factor is a ratio of category growth value and category size value for the product. The product share factor is a ratio of share change and brand share of the product. The product profit factor is a ratio of profit margin change and profit margin for the product. The product advertisement factor is a ratio of share of voice and share of market for the product. The product ROI factor is a ratio of short term return on investment and long term return on investment for the product. Finally, the marketing fund value is calculated which is based on a combined function of the product category factor, the product share factor, the product profit factor, the product advertisement factor, and the product ROI factor. It needs to be understood that the system and method as described herein enhance the efficiency of the computing system 102, specifically for providing the marketing resource allocation platform and determining the marketing investment value.

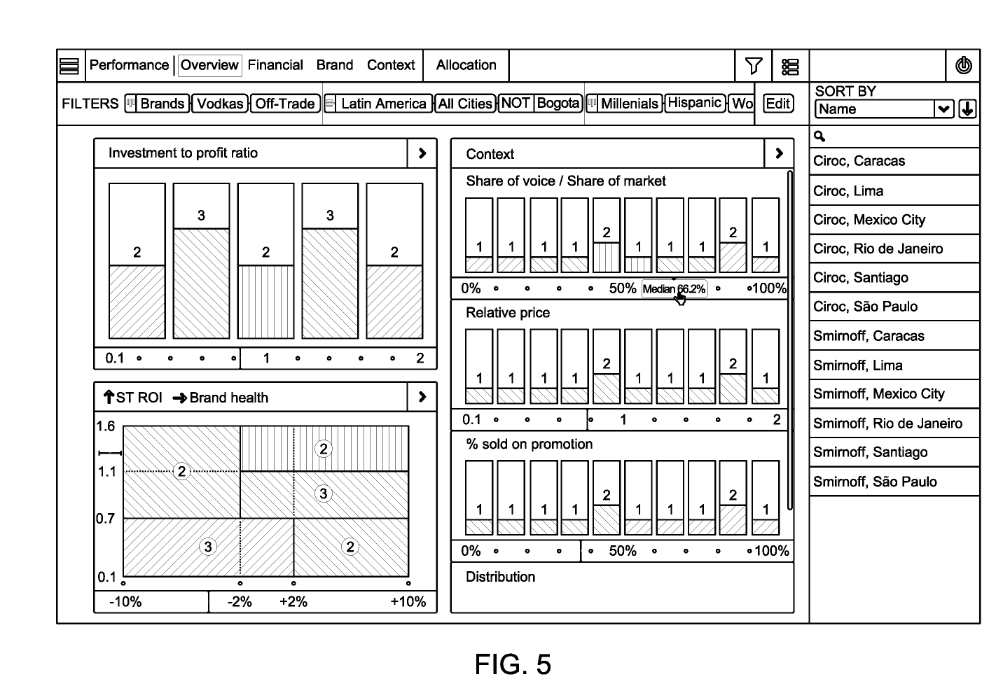

FIG. 5 illustrates a dashboard showing overall statistics of one or more brands of products, according to an embodiment. The dashboard displays various statistical analysis charts of a product in a geographical region. The statistical analysis may be performed based on a plurality of input variables that are determined based on data retrieved from a plurality of sources as described above. The statistical analysis may also be based on a plurality of dependent variables that are deduced by utilizing on one or more input variables. The figure illustrates statistics related to a product such as a Fast Moving Consumer Product (FMCG) in Latin America. The figure shows the investment to profit ratio for a product. For example, a product may be available under various brands. The dashboard may facilitate a user or a manager to view the investment to profit ratio with respect to various brands. In another scenario, the dashboard may display the investment to profit ratio of a particular product in various regions. The dashboard may also display share of voice to share of market ratio for product. Other statistical infographics such as relative price of a product/brand in various locations, percentage of products sold on promotion to distribution may be displayed.

A unique feature of the dashboard is that the statistical information can be displayed as a graph wherein the graph may be divided into a plurality of sections. For example, the figure shows Short Term ROI for a product being mapped with respect to brand health, such a mapping is divided into a plurality of sections wherein each section may be provided a particular significance based on user/manager criteria. For example, a brand that lies in the first section that signifies that the short term ROI is high but the brand health is low may lead to a 10% reduction in the marketing fund. Each section of the graph may be provided a particular weightage based on user defined criteria. Further, each graph or infographic displayed by the dashboard may be individually analyzed by a user by clicking on that particular graph.

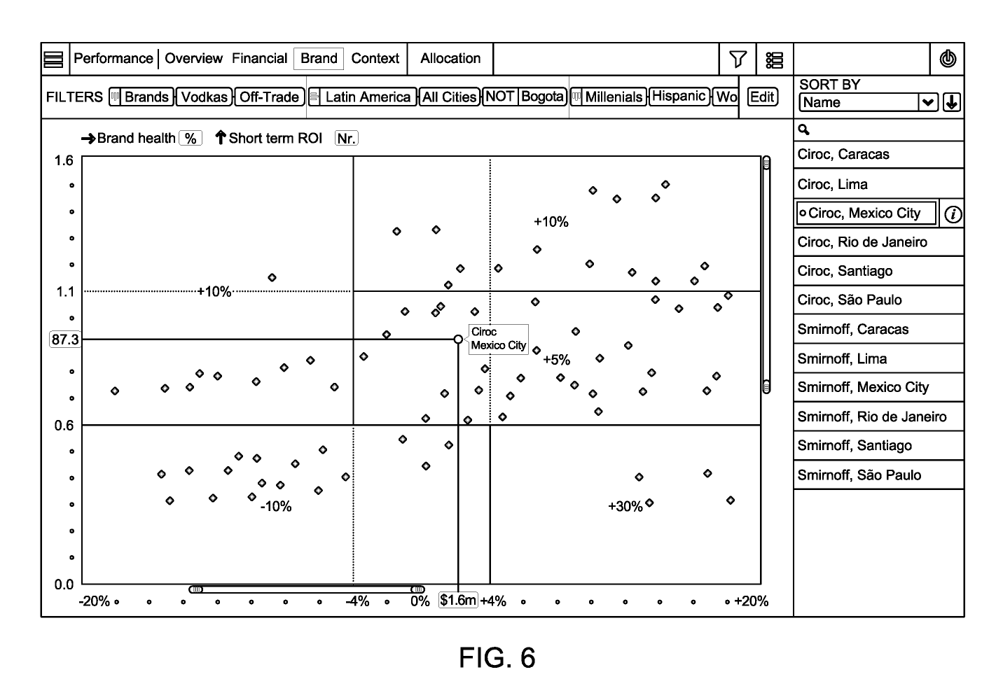

FIG. 6 illustrates a dashboard showing a chart depicting brand growth and short term ROI for a brand, according to an example embodiment. The figure shows a scatter plot graph of short term ROI to brand health in detail for a particular product available under various brands and in various regions. It can be noted that certain sections of the plot are provided with an increase or decrease in the marketing fund. For example, a brand having low short term ROI and low brand health may lead to a 10% reduction in the marketing budget. Similarly a brand having medium short term gains and medium brand health may lead to a 5% increase in the marketing budget. The figure shows an example plot and similar plots may be generated for various factors relevant in a particular industry.

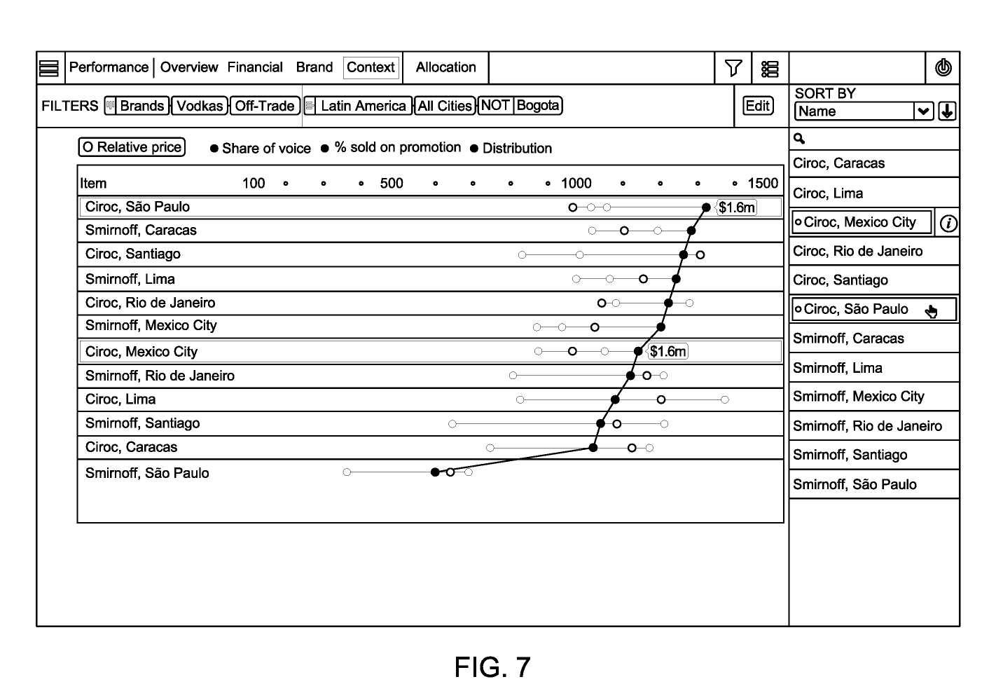

Each brand has a plurality of dependent variables such as share of voice, percentage sold on promotion, distribution, a relative price, and the like. These dependent variables may be represented by the dashboard in form of various charts or infographics. For example, FIG. 7 illustrates a dashboard showing a chart depicting relative prices of one or more brand of products in a plurality of locations, according to an embodiment. The figure illustrates an example chart of various brands of a product in a plurality of regions. The dependent variables such as share of voice, percentage sold on promotion, distribution, and a relative price for each of the brands of a product in the corresponding region. The list of brands and the corresponding regions have been sorted in the order of their relative price. Similarly, the list may also be sorted in the order of any other dependent variable. It may also be possible to determine the marketing fund value based on such an order.

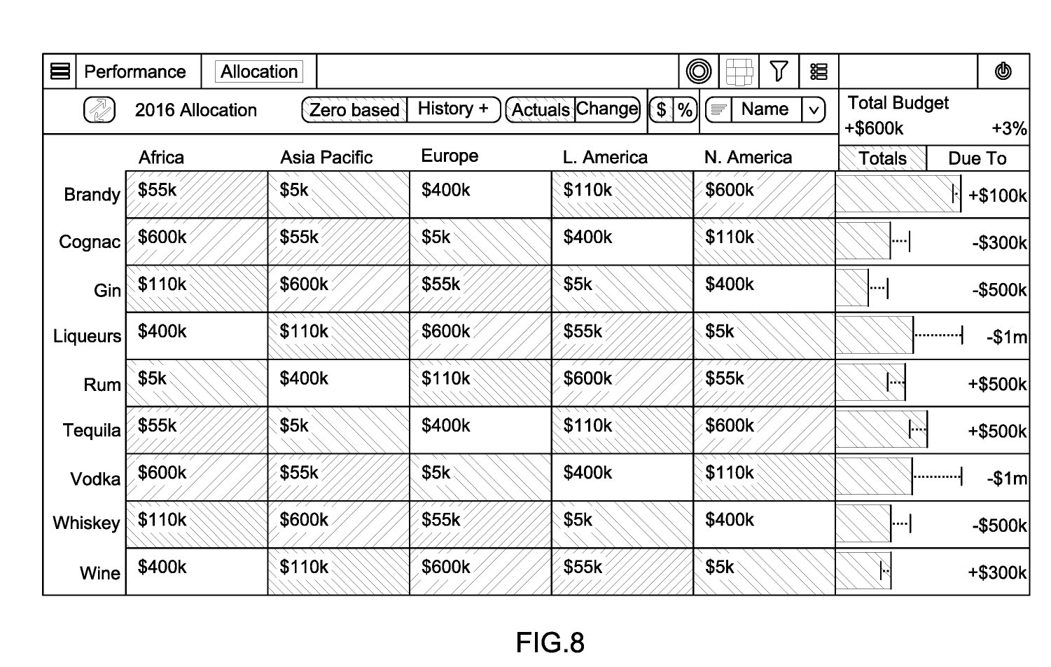

FIG. 8 illustrates a dashboard showing a chart depicting marketing fund allocation for various products in various corresponding geographical regions, according to an embodiment. The figure displays the marketing fund value for each of the products and the corresponding region where the marketing fund is to be allocated. The marketing fund value is determined according to the method steps described above. The marketing fund value is based on the combination of various dependent variables selected by the user/manager. The dashboard may also show the increase or decrease in the marketing fund value vis-à-vis the marketing fund allocated in a previous year. The marketing fund value may also be adjusted based on the factors such as short term ROI, Long term ROI, Strategic growth, and the like. Such factors may be provided adjustable weights.

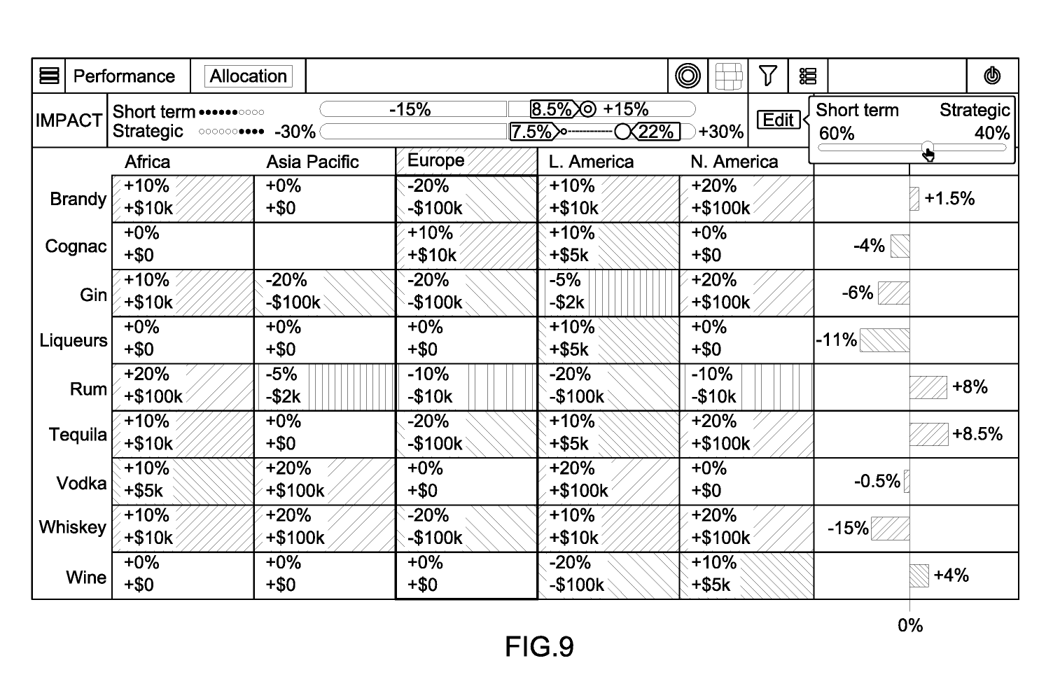

For example, FIG. 9 illustrates a dashboard showing a chart depicting change in marketing fund allocated to various products in various corresponding geographical regions. The marketing value is adjusted based on short term ROI and strategic growth factors. The short term ROI factor is weighted 60% and the strategic growth factor is weighted at 40% and accordingly the marketing fund values of the products for each corresponding region is changed. As an example, the marketing fund value determined based on one or more dependent variables and the historical budget for previous year may be changed by adjusting the weight given to short term ROI factor and the strategic growth factor.

Embodiments of the present disclosure may be provided as a computer program product, which may include a computer-readable medium tangibly embodying thereon instructions, which may be used to program a computer (or other electronic devices) to perform a process. The computer-readable medium may include, but is not limited to, fixed (hard) drives, magnetic tape, floppy diskettes, optical disks, compact disc read-only memories (CD-ROMs), and magneto-optical disks, semiconductor memories, such as ROMs, random access memories (RAMs), programmable read-only memories (PROMs), erasable PROMs (EPROMs), electrically erasable PROMs (EEPROMs), flash memory, magnetic or optical cards, or other type of media/machine-readable medium suitable for storing electronic instructions (e.g., computer programming code, such as software or firmware). Moreover, embodiments of the present disclosure may also be downloaded as one or more computer program products, wherein the program may be transferred from a remote computer to a requesting computer by way of data signals embodied in a carrier wave or other propagation medium via a communication link (e. g., a modem or network connection).

Moreover, although the present disclosure and its advantages have been described in detail, it should be understood that various changes, substitutions and alterations can be made herein without departing from the disclosure as defined by the appended claims. Moreover, the scope of the present application is not intended to be limited to the particular embodiments of the process, machine, manufacture, composition of matter, means, methods and steps described in the specification. As one will readily appreciate from the disclosure, processes, machines, manufacture, compositions of matter, means, methods, or steps, presently existing or later to be developed that perform substantially the same function or achieve substantially the same result as the corresponding embodiments described herein may be utilized. Accordingly, the appended claims are intended to include within their scope such processes, machines, manufacture, compositions of matter, means, methods, or steps.

1. A method for determining marketing fund value for a product, comprising
identifying, by a processor executing computer instructions, a plurality of input variables to estimate one or more dependent variables;
estimating one or more dependent variables by
determining a product category factor based on category growth value and category size value for the product;
determining a product share factor based on share change and brand share of the product;
determining a product profit factor based on profit margin change and profit margin for the product;
determining a product advertisement factor based on share of voice and share of market for the product; and
determining a product ROI factor based on short term return on investment and long term return on investment for the product; and
calculating the marketing fund value based on a combined function of one or more dependent variables.

2. The method as claimed in claim 1, wherein the step of identifying the plurality of input variables comprises of
retrieving data related to the plurality of input variables from a plurality of sources; and
refining the retrieved data.

3. The method as claimed in claim 1, wherein calculating the marketing fund value comprises of
determining a future profit potential factor by multiplying the product category factor, product share factor, and product profit factor; and
adding the future profit potential factor with the product advertisement factor, and the product ROI factor.

4. The method as claimed in claim 1, wherein calculating the marketing fund value comprises of
adding the product category factor, the product share factor, the product profit factor, the product advertisement factor, the product ROI factor, and a historic budget value.

5. The method as claimed in claim 4, wherein the historic budget value is the total budget allocated to the product in a previous financial year.

6. The method as claimed in claim 1, wherein the step of estimating one or more dependent variables further comprises determining a product investment factor, the product investment factor is based on investment in marketing of the product and profit of the product.

7. A system for displaying a marketing fund value for one or more products, the system comprising
one or more databases to store data related to one or more input variables;
a memory for storing one or more input variables, one or more dependent variables, and one or more program modules;
a processor to execute the one or more program modules stored in the memory for:
identifying a plurality of input variables to estimate one or more dependent variables, wherein the input variables are stored in one or more databases;
estimating one or more dependent variables by
determining a product category factor, the product category factor is based on a category growth value and a category size value for the product;
determining a product share factor, the product share factor is based on a share change and a brand share of the product;
determining a product profit factor, the product profit factor is based on a profit margin change and a profit margin for the product;
determining a product advertisement factor, the product advertisement factor is based on a share of voice and a share of market for the product; and
determining a product ROI factor, the product ROI factor is a ratio of short term return on investment and long term return on investment for the product;
calculating the marketing fund value based on a combined function of one or more dependent variables; and
displaying the marketing fund value for each of the one or more products along with the one or more dependent variables.

8. The system of claim 7, wherein the marketing fund value is displayed by displaying a dashboard containing one or more infographics.

9. A non-transitory computer readable medium storing computer readable instructions that when executed by a processor perform a method for determining marketing fund value for a product, the method comprising
identifying, by a processor executing computer instructions, a plurality of input variables to estimate one or more dependent variables, wherein the input variables are stored in one or more databases;
estimating one or more dependent variables by
determining a product category factor, the product category factor is a ratio of category growth value and category size value for the product;
determining a product share factor, the product share factor is a ratio of share change and brand share of the product;
determining a product profit factor, the product profit factor is a ratio of profit margin change and profit margin for the product;
determining a product advertisement factor, the product advertisement factor is a ratio of share of voice and share of market for the product; and
determining a product ROI factor, the product ROI factor is a ratio of short term return on investment and long term return on investment for the product; and
calculating the marketing fund value based on a combined function the one or more dependent variables.
